(19) United States
(12) Patent Application Publication
(10) Pub. No.: US 2020/0361131 A1
(43) Pub. Date: Nov. 19, 2020

(54) METHOD FOR OPERATING AN EXTRUDER, AND EXTRUDER

(71) Applicant: KRAUSSMAFFEI EXTRUSION GMBH, Hannover (DE)

(72) Inventor: Harald Hepke, Hannover (DE)

(21) Appl. No.: 16/963,876

(22) PCT Filed: Jan. 24, 2019
(86) PCT No.: PCT/EP2019/051786

§ 371 Date: Jul. 22, 2020

(30) Foreign Application Priority Data
Feb. 7, 2018 (DE) 10 2018 102 738.9

(51) Int. Cl. B29C 48/25; B29C 48/40; B29C 48/92; B29B 7/72; B29C 48/49

(52) U.S. Cl. CPC B29C 48/2692; B29C 48/404; B29C 48/92; B29C 2948/9298; B29C 48/49; B29C 2948/92295; B29C 2948/92485; B29B 7/72

(57) ABSTRACT

A method for operating an extruder that has a screw, including the steps: (a) detection of a formulation identifier which is associated with material to be extruded and which encodes at least one operating variable, from which an ideal screw rotational frequency of the screw, which is to be set for the extrusion process, can be determined, (b) time-dependent detection of a throughput parameter, from which a throughput of the extruder can be deduced, (c) detection of a non-conformance point in time, at which the material can no longer be produced with a predefined quality, owing to excessive wear of the extruder, and (d) calculation of a limit throughput parameter from the throughput parameter, linking of the limit throughput parameter to the formulation identifier, and storing of the limit throughput parameter.

The invention concerns a method for operating an extruder. According to a second aspect, the invention concerns an extruder.

The invention relates in particular to a method for producing car tyres and components of car tyres, for example treads, by means of an extruder. Extruders have a screw which runs in a cylinder, in order to convey and, in so doing, knead, if applicable heat and finally deliver under pressure to an injection head, material which is to be extruded, which according to a preferred embodiment is a rubber mixture.

The screw wears. Thereby, a gap enlarges between the outer edge of the screw and an inner surface of the cylinder, in which the screw runs. Material which is to be extruded flows through this gap contrary to a material flow direction. In order to achieve a predetermined throughput, a rotational frequency of the screw must be increased, the greater the wear is. The throughput is the amount of extruded material which is delivered to the injection head during operation of the extruder.

The greater the stream of material which is to be extruded which flows through the gap contrary to the material flow direction, and the greater, in reaction thereto, the rotational frequency of the screw is adjusted, in order to achieve a predetermined target throughput, the more heat is introduced into the material which is to be extruded. Indeed, it is possible, and is provided according to a preferred embodiment of the method, that the material which is to be extruded is cooled by means of a cooling device of the extruder. Nevertheless, an increase in the screw rotational frequency generally leads to the temperature of the material which is to be extruded increasing at the point at which the material leaves the extruder.

When a critical temperature is exceeded, this leads to the rubber mixture being partly vulcanized and therefore becoming unusable for further processing. For this reason, the screw must be exchanged when the wear has progressed too far. The measuring of the wear is, hitherto, laborious. For this, it is necessary for example to dismantle the screw and measure it. For this reason, the screw is changed after a predetermined number of operating hours, irrespective of the wear which is actually present. Thereby, it is prevented that the wear becomes too high during production and thereby a pause in production arises. A disadvantage to this course of action is that the screw is generally changed too early.

The invention is based on the problem of reducing disadvantages in the prior art.

The invention solves the problem by a method for operating an extruder which has a screw, with the steps (a) detecting a recipe identifier which is assigned to material which is to be extruded and encodes at least one parameter from which a target screw rotational frequency fᵢ of the screw, which is to be pre-set at the extrusion, is able to be determined, (b) time-dependent detecting of a throughput parameter, from which a conclusion can be drawn regarding a throughput of the extruder, in particular per revolution of the screw, (c) detecting a fault time t_{P} at which the extruder is no longer able to be operated owing to a wear which is too high, and (d) calculating a threshold throughput parameter Mᵢ(t_{P}) from the throughput parameter M, linking the threshold throughput parameter Mᵢ(t_{P}) with the recipe identifier Rᵢ (and if applicable with the error time t_{P}) and storing the threshold throughput parameter Mᵢ(t_{P}).

It is advantageous in this method that in this way information is obtained concerning the throughput at which the introduced thermal output with a predetermined recipe becomes so great that a predetermined quality of the extruded product no longer exists.

Within the scope of the present description, the recipe identifier is understood to mean in particular a piece of data, for example a number, a quantity of numbers or a vector which encodes the information which is necessary for the processing of a particular material. In particular, by means of the recipe identifier it is established which material is to be extruded and is therefore delivered to the extruder.

Preferably, the recipe identifier encodes in addition a product dimension.

The recipe identifier encodes in addition a parameter from which the target screw rotational frequency of the screw is able to be determined. For example, the parameter is the target screw rotational frequency itself. Alternatively, the parameter can be the output of the extruder which is to be set, a target throughput in weight per unit of time and/or a target production speed. However, it is basically conceivable and is included by the invention that the recipe identifier encodes a corresponding parameter. In other words, it is sufficient that the recipe identifier is assigned exclusively to the material which is to be extruded.

The time-dependent detecting of the throughput parameter is understood to mean in particular that the throughput parameter is detected at least once per minute, preferably at least once per 10 seconds, preferably at least once per second. It is possible that the time-dependent detecting is carried out on the basis of an external signal, for example from a central control unit.

The feature that a conclusion can be drawn regarding the throughput of the extruder from the throughput parameter is understood to mean in particular that the throughput indicates which mass of extruded material is delivered from the extruder per unit of time or per revolution of the screw.

When time is mentioned, this means either the real time or a machine time which increases in a strictly monotonic manner with the real time in operation. Unlike the real time, however, the machine time can stop, for example when the extruder is not being operated or is reset, for example after a change of screw.

The fault time is preferably indicated in the machine time, for example in number of hours since the last change of the screw of the corresponding extruder.

The fault time is the time at which the extruder delivers extruded material which no longer corresponds to the required quality of the product and/or at which the extruder no longer reaches a predetermined target production speed. This quality refers for example to whether the material is completely non-vulcanized. It is possible, but not necessary, that the quality of the product is described in objectively measurable parameters. It is only important that the fault time encodes the time at which the extruded material is regarded as being no longer acceptable.

For example, the fault time is the time at which a predetermined maximum temperature of the extruded material is exceeded at least locally. It is possible, but not necessary, that the temperature of the extruded material is measured and the fault time is thereby determined from this temperature, in particular in that the time of the exceeding of the maximum temperature is set as the fault time.

Starting from a certain wear, the screw rotational frequency must be increased in order to reach the target production speed. If a further increase in the screw rotational frequency is not possible, because that would lead to too high a thermal load, the production speed falls below the target production speed. This is a possible criterion in order to assume that a screw is too intensively worn.

The feature that the threshold throughput parameter is calculated from the throughput parameter is understood to mean in particular that the threshold throughput parameter, equal to the throughput parameter, is set at a time which lies within an equal wear interval about the fault time. The equal wear interval is a time interval at which it can be concluded that the wear of the screw has not changed significantly. For example, the interval length of the equal wear interval is at most three months, in particular at most one month and/or at least one day.

The feature that the threshold throughput parameter is linked with the recipe identifier is understood to mean in particular that the corresponding data are stored so that on interrogating the threshold throughput parameter, it is able to be established unequivocally to which recipe identifier this belongs. It is beneficial, but not necessary, that the fault time tₚ is also linked with the threshold throughput parameter and the recipe identifier. The threshold throughput parameter, linked with the recipe identifier and if applicable with the fault time, forms a fault dataset.

It is beneficial if the recipe encodes the production speed at which the material which is to be extruded must be delivered.

According to a preferred embodiment, for recipe identifiers of material which is processed within the equal wear interval about the fault time, the throughput parameter which is linked with the corresponding recipe identifier and with a time stamp, by means of which a conclusion can drawn with regard to the fault time, is stored as equivalent throughput parameter M_{ieq}(t_{P}). In particular, this throughput parameter is linked with the fault time t_{P} itself, even when the material is not processed precisely at the fault time. Material which is to be extruded, which belongs to different recipe identifiers, can react with different sensitivity to the wear of the extruder. It is frequently known heuristically that a particular material reacts sensitively or insensitively to wear. If it is known that the material reacts insensitively to wear, it can be processed although the preceding material was already no longer able to be processed.

It is also possible that the new material with the new recipe identifier is only processed for the purpose in order to establish whether also in the case of this material the wear of the extruder is already so great that the required throughput is not able to be achieved with the predetermined quality. These data lead to a data collection from which it can be gathered, in the form of a throughput characteristic diagram, at which specific throughput the material which has a particular recipe identifier can no longer be processed.

[Claim 3] The method preferably comprises the steps

(a) changing, at a change time t_{W}, the material which is to be extruded from a current material with a current recipe identifier Rᵢ to a future material with a future recipe identifier Rⱼ,

(b) detecting the throughput parameter Mᵢ(t_{W}) for the material with the current recipe identifier Rᵢ at the change time t_{W} or at a change time t_{W,e} equivalent thereto, which lies within the equal wear interval Iₑ about the change time t_{W},

(c) detecting the throughput parameter Mⱼ(t_{W}) for the material with the future recipe identifier Rⱼ at the change time t_{W} or at a change time t_{W,e} equivalent thereto, which lies within the equal wear interval Iₑ about the change time (t_{W}), and

(d) storing an equivalent throughput characteristic diagram which links the throughput parameter Mᵢ(t_{W}) for the material with the current recipe identifier Rᵢ at the change time t_{W} or equivalent change time t_{W,e} with the throughput parameter Mⱼ(t_{W}) for the material with the second recipe identifier Rⱼ at the change time (t_{W}) or equivalent change time (t_{W,e}).

The detecting of the throughput parameter at the time within the equal wear interval is based on the knowledge that the wear within the equal wear interval only changes to a negligibly small extent. With each change of the recipe, an indication is therefore obtained as to what influence the viscosity in the remaining characteristics of the material with a predetermined recipe identifier has on the throughput with an unknown but given wear. On the basis of these data, a conclusion can be drawn as to what wear is to be expected when the material is changed over with an already measured recipe identifier. In particular, through the named method steps, from a throughput parameter for a material with a first, current recipe identifier, a conclusion can be drawn with regard to the throughput parameter to be expected through the material with a second, future recipe identifier.

[Claim 4] It is advantageous if, before a change from material with the current recipe identifier to the material with the future recipe identifier (i) the current throughput parameter is detected for the material with the current recipe identifier, and (ii) the equivalent throughput characteristic diagram is interpolated, so that from the throughput parameter for the material with the current recipe identifier at the current change time, the throughput parameter for the material with the future recipe identifier is obtained at the current change time. In this way, an estimated throughput parameter is obtained.

It is advantageous that an alarm is emitted when the throughput parameter which has been calculated in this way for the material with the future recipe identifier falls below a predetermined minimum throughput parameter, which is assigned to the recipe identifier. This minimum throughput parameter is preferably the threshold throughput parameter which is obtained when an error time was detected for the corresponding recipe identifier. If no error time was detected, then preferably a predetermined estimated value, which was estimated by way of example, is used as minimum throughput parameter.

According to a preferred embodiment, before a change from a current material with a current recipe identifier to a future material with a future recipe identifier, the following steps are carried out: (a) determining the closest time at which for the throughput parameter with the current recipe identifier an equivalent throughput parameter exists for the future recipe identifier, (b) determining a difference between the throughput parameters, (c) adding a wear progress value, which is calculated from this difference, to the throughput parameter of the current recipe identifier, so that an estimated throughput parameter is obtained for the future recipe identifier, and (d) when the estimated throughput parameter lies below the threshold throughput parameter of the future material with the future recipe identifier, emitting an alarm.

The calculating of the wear progress value from the difference between the two throughput parameters is understood to mean in particular in the simplest case that the wear progress value is equal to the difference. However, it is also possible that this difference is multiplied with a correction value, which for example is calculated form the wear curves for the two recipe identifiers. The basis for this method is the assumption that the differences in the throughputs change little with increasing wear.

The emitting of an alarm is understood to mean in particular that a signal, which is perceptible or not perceptible by a person, is emitted, which encodes the circumstance that it is to be reckoned thereby that during extruding of the future material the predetermined quality is not reached. It is possible that the alarm is transmitted to a central computer at a spatial distance, for example a computer which is situated with a manufacturer or maintenance company of the extruder, or is operated by the latter, so that the delivery of a new screw can be initiated.

Alternatively or additionally, before a changeover from the current material to the future material, the closest time is determined at which for the throughput parameter with the current recipe identifier an equivalent throughput parameter exists for the future recipe identifier, thereafter the quotient of the throughput parameter is determined. From this quotient, a wear progress factor is calculated, wherein the wear progress factor can be the quotient itself. The wear progress factor is multiplied with the throughput parameter of the current recipe identifier, so that a second estimated throughput parameter is obtained. When the second estimated throughput parameter lies below the threshold throughput parameter of the future material with the future recipe identifier, the alarm is emitted.

It is pointed out that the designation as second estimated throughput parameter does not mean that necessarily the first throughput parameter must be calculated. This is merely a simpler form of nomenclature. It is also possible that the first and the second estimated throughput parameters are calculated, wherein for the comparison with the threshold throughput parameter a mean value, weighted if applicable, of both estimated throughput parameters is used.

Preferably, the method comprises the steps (a) for at least one predetermined recipe identifier, which can be designated as reference recipe, determining the throughput parameter as a function of time, in particular also from throughput parameters during extruding of materials and other recipe identifiers, and (b) calculating an error time estimated value, at which the minimum throughput parameter for the predetermined recipe identifier would fall below the minimum throughput parameter which is assigned to the recipe identifier, through extrapolating the throughput parameter as a function of time. It is advantageous if the error time estimated value is emitted in the form of a notification.

Preferably, the method comprises the step that for a predetermined quantity of recipes, which are fitted with a parametrised model function according to the throughput parameter, fit parameters are obtained, wherein the extrapolating of the throughput parameter takes place by means of the model function with the fit parameters.

In the simplest case, the model function can be a linear function. In this case, the throughput parameter is described as a linear function dependent on time, which is measured in operating hours. However, it is also possible that the model function contains higher order terms, in particular those which depend on time quadratically or to the power of three.

The method preferably comprises the step of a resetting to zero of the time after an exchange of the screw. It is possible to carry out the said method only over the period of time over which a predetermined screw is used. However, with good reason it can be assumed that the wear behaviour of the screws is essentially identical, so that from the wear behaviour of a screw, a conclusion can be drawn regarding the wear behaviour of the subsequent screw.

The invention solves the problem in addition by a method for operating an extruder which has a screw, with the steps: (a) detecting a recipe identifier Rᵢ, which is assigned to material which is to be extruded and encodes at least one parameter from which a target screw rotational frequency fᵢ of the screw, which is to be preset at the extrusion, is able to be determined, (b) time-dependent detecting of a throughput parameter Mᵢ(t), from which a conclusion can be drawn regarding a throughput Δm of the extruder, in particular a throughput per revolution of the screw, (c) at a change time t_{W1} changing the material which is to be extruded to a material with a second recipe identifier Rⱼ, (d) detecting the throughput parameter Mᵢ(t_{W1}) for the material with the first recipe identifier Rᵢ at the change time t_{W1} or at a change time t_{W1,e} equivalent thereto, which lies within an equal wear interval Iₑ, in particular within a week, about the change time t_{W1}, (e) detecting the throughput parameter Mⱼ(t_{W1}) for the material with the second recipe identifier Rⱼ at the change time t_{W1} or a change time t_{W1,e} equivalent thereto, which lies within an identical wear interval Iₑ about the change time t_{W1}, (f) storing an equivalent throughput characteristic diagram K, which links the throughput parameter Mᵢ(_{tW1}) for the material with the first recipe identifier Rᵢ at the change time t_{w1} or the equivalent change time t_{W1,e} with the throughput parameter Mⱼ(t_{W1}) for the material with the second recipe identifier Rⱼ at the change time t_{W1,e}.

In so far as within the equal wear interval Iₑ further material changes take place, then the throughput parameters for the corresponding recipes are detected according to the procedure with the material with the second recipe identifier and are stored in the equivalent throughput characteristic diagram.

Preferably, the method comprises the steps (a) determining a recipe identifier as reference recipe identifier and (b) determining the equal wear intervals from the change times t_{Wk} of the recipe reference recipe identifier. In other words, a recipe exists which preferably concerns the most frequently used recipe, relative to which the throughput parameters are referenced.

Preferably, the method comprises the steps (a) detecting an error time t_{P}, at which the extruder, owing to too great a wear, is no longer able to be operated with the target screw rotational frequency (because otherwise the required quality of the product is no longer guaranteed), (b) determining the throughput parameter Mᵢ(t_{P}) at a time t_{P} in the equal wear interval Iₑ, (c) determining the minimum throughput parameter M_{i,min} from this throughput parameter Mᵢ(t_{P}), in particular by equalizing of minimum throughput parameter M_{i,min} and throughput parameter Mᵢ(t_{P}). It is advantageous herein that, as described above, a throughput parameter is obtained from which it is known that the material with the assigned recipe identifier at the given wear can no longer be processed. The particular embodiments described above for the first aspect of the invention also relate to the second method according to the invention.

According to the invention in addition is a method for operating an extrusion system which has a first extruder, a second extruder and at least a third extruder, wherein the method is carried out for the majority of the extruders, in particular for all extruders.

According to the invention in addition is an extruder with a cylinder, at least one screw which runs in the cylinder, and a control unit which is arranged for automatically carrying out a method according to the invention. Preferably, the control unit has a digital memory in which a program is stored, which encodes the method.

According to a preferred embodiment, the control unit is connected or is able to be connected with a data network for transmitting the throughput parameters or parameters calculated therefrom, in particular of fit parameters, to a central computer situated spatially at a distance. The central computer can, for example, be more than one kilometre distant from the control unit closest to it. This makes is possible for the manufacturer of the extruders or a servicing company, to monitor the development of the wear and to promptly deliver an exchange screw, for example.

According to the invention, in addition is an extrusion system with at least three extruders, which respectively have at least one screw, and a control unit which is arranged to automatically carry out a method according to the invention. It is possible, but not necessary, that the control unit is distributed to several sub-control units.

The invention is explained further below with the aid of the enclosed drawings. There are shown here

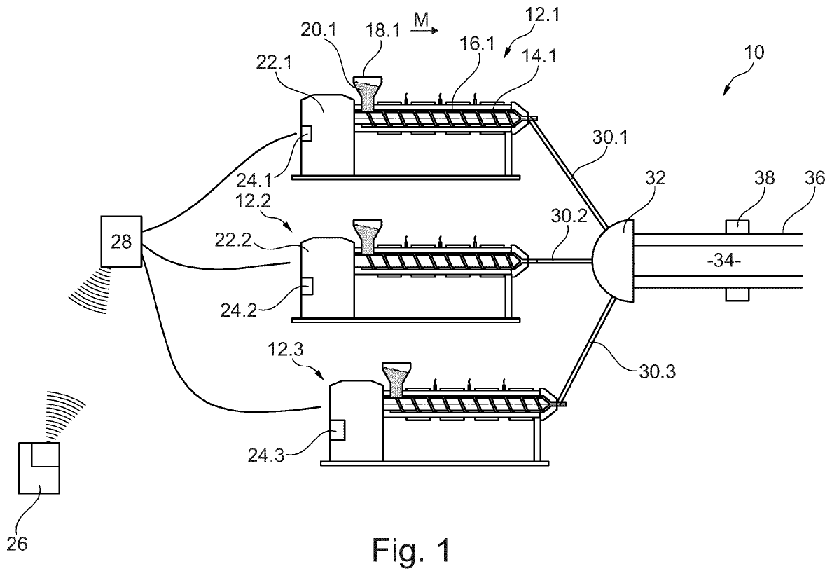

FIG. 1 an extrusion system according to the invention, with extruders according to the invention for carrying out a method according to the invention,

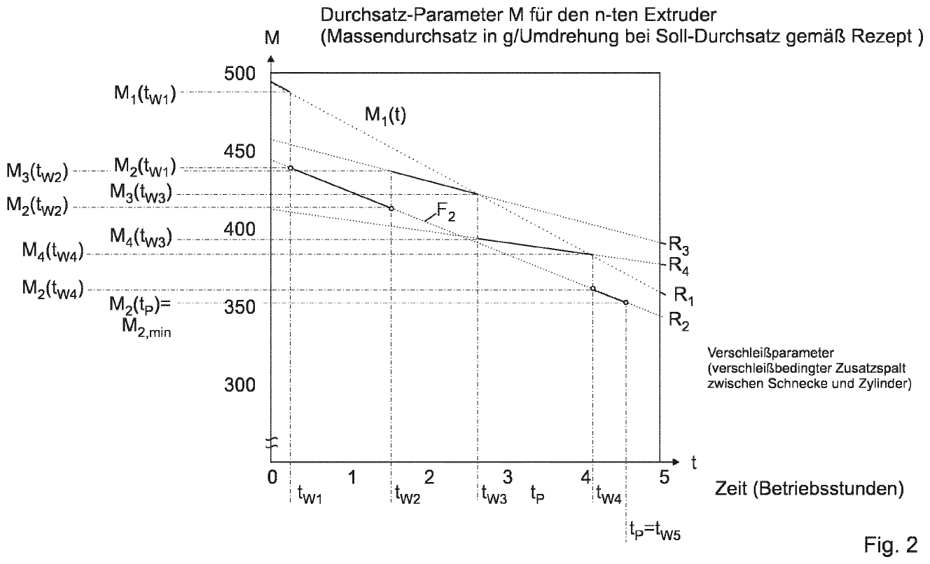

FIG. 2 a diagram, in which the progression of the throughput parameters for several recipe identifiers is recorded schematically over time,

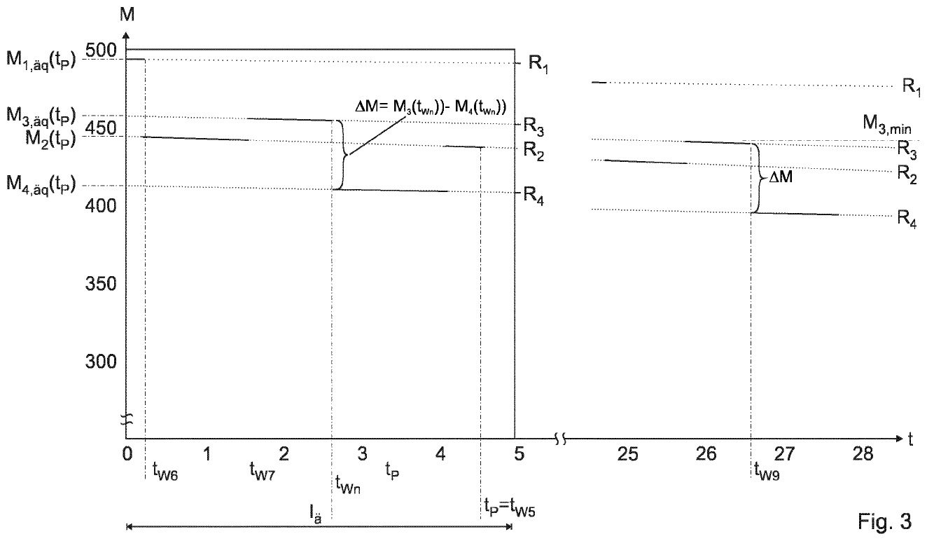

FIG. 3 a comparable diagram to that according to FIG. 2, wherein the time over which a recipe is respectively processed, is shorter than in the case of FIG. 2.

FIG. 1 shows an extrusion system 10 according to the invention with a first extruder 12.1, a second extruder 12.2 and a third extruder 12.3. The first extruder has a first screw 14.1, which runs in a cylinder 16.1. By means of a material feed 18.1, material 20.1 to be extruded is fed to the extruder 12.1.

The extruder 12.1 has a drive 22.1 in the form of an electric motor for rotating the screw 14.1. A control unit 24.1 controls the drive 22.1 so that the latter brings about a predetermined screw rotational frequency f. The control unit 24.1 can communicate with a central computer 26. It is possible that in addition an intermediate computer 28 is used. The control unit 24 comprises a digital memory in which a program is stored which, during operating, brings it about that the method described below is implemented.

Firstly, a recipe identifier Rᵢ of material which is to be extruded is detected. The index i is a running index, which could also be designated as a recipe index, because thereby the different recipes are numbered consecutively. A recipe contains for example an indication of the components of the material 20.1 which is fed to the extruder 14.1.

The recipe Rᵢ comprises in addition an indication of a target screw rotational frequency f_{i,soll}, which is to be preset at the extrusion of the material 20.1. Generally, this target screw rotational frequency f_{i,soll} refers to a predetermined throughput m, which refers to the quantity of material which is delivered by the extruder 12.1 per revolution of the screw 14.1. From the throughput m and the screw rotational frequency fᵢ therefore a mass throughput can be calculated which is measured in kilograms per unit of time and indicates how many kilograms of extruded material are delivered by the extruder 12.1 per unit of time.

The extruder 12.1 delivers the extruded material to an injection head 32 via a line 30.1. The remaining extruders of the extrusion system 10, in the present case therefore the extruders 12.2 and 12.3, deliver respectively extruded material via corresponding lines 30.2, 30.3 to the injection head 32, where a profile 34 is injected from the combined streams of material. The profile 34 runs on a conveyor 36, for example a conveyor belt, for further processing.

A scales 38 determines the weight of a portion of the profile 34, so that a section weight G, which is also designated as a metre weight, of the profile 34 can be determined. As the portion of the material which comes from a specific extruder is known in the profile, from this information and from the measured metre weight and from a speed at which the profile 34 is moving, the throughput in kilograms per unit of time of all extruders can be determined. The speed at which the profile 34 is moving is likewise measured, for example by measuring a rotational speed of a roll over which the profile 34 rolls. The extruders 12.2 and 12.3 and any further extruders which are present are respectively constructed identically, however it is also possible that they differ in their type of construction. The essential characteristics of the extruders which are relevant for the invention are, however, those described above.

The respective control units 24 (reference numbers without numerical index refer respectively to all corresponding objects) detect the respective screw rotational frequency fᵢ. As generally the throughput is indicated in mass per unit of time and according to a preferred embodiment is part of the recipe, from the screw rotational frequency fᵢ the throughput per screw revolution can be calculated, namely as a quotient of throughput in weight or mass per unit of time with the target throughput according to the recipe. The target throughput is indicated in mass or weight per minute. When wear occurs, then the screw rotational frequency fᵢ must be increased, in order to achieve the target throughput. This generally takes place manually, but can also take place automatically.

FIG. 2 shows diagrammatically that the throughput parameter M decreases with the time t, which is measured in operating hours. At the start of the observation, in particular after the installation of a screw into the extruder, firstly material is extruded with the recipe identifier R₁. It can be seen that the target throughput lies just below 500 grams per screw revolution.

This recipe identifier is detected by the control unit 24 for example in that it is inputted by an operator via an operator interface. From the recipe identifier R₁, the control unit 24 determines the screw rotational frequency f₁ which is firstly to be selected. During the extruding, the throughput parameter M is detected continuously in the form of the mass throughput per screw revolution, for example once per second or once per 10 seconds.

At a change time t_{W1} firstly the respectively current throughput parameter M₁(t_{W1}) is stored. Thereafter, the material is processed according to a second recipe identifier R₂. At the start of the processing, the throughput parameter M₂(t_{W1}) is determined. The same takes place at a time t_{W2} on a change from the material with the second recipe identifier to the material with the third recipe identifier R₃.

At a time t_{W5}, at which the material is processed according to the second recipe identifier R₂, the screw rotational frequency f₂ would have to be selected to be so high, in order to achieve the predetermined target throughput, that too intensive a heating of the material to be extruded, and local complete vulcanization would occur. The throughput parameter M at this time is M₂(t_{P}). It is stored as threshold throughput parameter. For a later recurring processing of the material according to the recipe identifier R₂ it is known from then that it must be ensured that the throughput parameter M₂ always lies above this threshold throughput parameter M_{2,min}.

In FIG. 1 the case is shown in which the materials are exchanged with respect to the corresponding recipe identifiers so rarely that the wear during processing of only one material already clearly progresses. However, the case occurs more frequently in which different materials with different recipe identifiers are changed so frequently that the wear during the processing of the material with a particular recipe identifier is small. This case is indicated schematically in the diagram according to FIG. 3. It can be seen that during an equal wear interval Iₑ, the wear decreases only so little that it can be regarded as constant. For this reason, in good approximation the throughput parameters M_{3,eq} (t_{P}), M₂(t_{P}), M_{4,eq}(t_{P}) can be regarded as belonging to the same wear state.

If for example at a distinctly later time t_{W9} a change is made from the material with the recipe identifier R₃ to the recipe identifier R₄, then in an approximation it can be assumed that a difference ΔM=M₃(t_{Wn})−M₄(t_{Wn}) has remained the same. Therefore this difference, which in this case is regarded as wear progress summand, is added to the throughput parameter M₄(T_{W9}). If it should transpire that the value thus obtained lies below the threshold parameter M_{3,min} for the recipe production R₃, which is charted schematically, then an alarm is emitted.

Alternatively, it is possible that instead of the difference, the quotient is formed from the throughput parameters, in the present case this would be M₃(t_{Wn})/M₄(t_{Wn}) When material with a recipe identifier is used particularly frequently, it is expedient to regard this recipe identifier as reference recipe identifier.

In FIG. 2, the measurement points are indicated schematically at which at least for the recipe with the recipe identifier R₂ the throughput parameters are determined. When a plurality of these parameters exists, then the wear curve can be adapted with a model curve which in the present case is drawn in dashed lines. For example, as in the case shown in FIG. 2, this is a straight line. With sufficiently many measurement points, the parameters of the model function can be selected so that the model function is adapted optimally to the measurement data. This curve fitting belongs to the prior art and is therefore not described further.

Through the adapting to the model function, fit parameters are obtained which describe the chronological development of the throughput parameter M₄ for the material with the recipe identifier Rᵢ. As soon as these are obtained, the time at which the specified or determined minimum throughput parameter M_{i,min} would be fallen below can be determined therefrom. This value can be interrogated in an automated manner or in response to a corresponding enquiry by the user via the user interface of the respective control unit 24 or via the intermediate computer 28 or through the central computer 26.

### LIST OF REFERENCE NUMBERS

10 extrusion system
12 extruder
14 screw
16 cylinder
18 material feed
20 material
22 drive
24 control unit
26 central computer
28 intermediate computer
30 line
32 injection head
34 profile
36 conveyor
38 scales
f_{i,soll} target screw rotational frequency
fᵢ screw rotational frequency
G metre weight
i recipe index
m throughput (Kg/R)
M material flow direction
R recipe

What is claimed is:

1. A method for operating an extruder (10), which has a screw (14), with the steps:
(a) detecting a recipe identifier (Rᵢ), which
is assigned to material (20) to be extruded and
encodes at least one parameter, from which a target screw rotational frequency (f_{i,soll}) of the screw (14) is able to be determined, which is to be preset at the extrusion,
(b) time-dependent detecting of a throughput parameter (M), from which a conclusion can be drawn regarding a throughput (m) of the extruder (12),
(c) detecting an error time (t_{P}) at which the material (20), owing to too great a wear of the extruder (12), is no longer able to be produced with a predetermined quality and
(d) calculating a threshold throughput parameter (Mᵢ(t_{P})) from the throughput parameter (M), linking with the recipe identifier (Rᵢ) and storing of the threshold throughput parameter (Mᵢ(t_{P})).

2. The method according to claim 1, further comprising the step:
for recipe identifiers (Rⱼ) of material (20), which is processed within an equal wear interval (Iₑ), about the error time (t_{P}):
storing of the throughput parameter (Mᵢ(t)) linked with the recipe identifier (Rⱼ) and a time stamp (t_{P}), by means of which a conclusion can be drawn regarding the error time (t_{P}), as equivalent throughput parameter (M_{i,eq}(t_{P})).

3. The method according to claim 1, further comprising the steps:
(a) at a change time (t_{W}) changing the material (20) to be extruded from a current material (20) with a current recipe identifier (Rᵢ) to a future material (20) with a future recipe identifier (Rⱼ),
(b) detecting the throughput parameter (Mᵢ(t_{W})) for the material (20) with the current recipe identifier (Rᵢ) at the change time (t_{W}) or at an equivalent change time (t_{W,e}) thereto which lies within the equal wear interval (Iₑ) about the change time (t_{W}),
(c) detecting the throughput parameter (Mⱼ(t_{W})) for the material (20) with the future recipe identifier (Rⱼ) at the change time (t_{W}) or at an equivalent change time (t_{W,e}) thereto, which lies within the equal wear interval (Iₑ) about the change time (t_{W}), and
(d) storing of an equivalent throughput characteristic diagram, which links the throughput parameter (Mᵢ(t_{W})) for the material (20) with the current recipe identifier (Rᵢ) at the change time (t_{W}) or equivalent change time (t_{W,e}) with
the throughput parameter (Mⱼ(t_{W})) for the material (20) with the second recipe identifier (Rⱼ) at the change time (t_{W}) or equivalent change time (t_{W,e}).

4. The method according to claim 3, further comprising the steps:
(i) before a change of material (20) with a current recipe identifier (Rₐ) to material (20) with a future recipe identifier (R_{z})
detecting the current throughput parameter (Mₐ(t_{Wa})) for the material (20) with the current recipe identifier (Rₐ) at the current change time (t_{Wa}) and
(ii) interpolating the equivalent throughput characteristic diagram, so that from the throughput parameter (Mₐ(t_{Wa})) for the material (20) with the current recipe identifier (Rₐ) at the current change time (t_{Wa}) the throughput parameter (M_{z}(t_{Wa})) for the material with the future recipe identifier (R_{z}) at the current change time (t_{Wa}) is obtained.

5. The method according to claim 1, further comprising the steps:
before a change from a current material (20) with a current recipe identifier (Rᵢ) to a future material (20) with a future recipe identifier (Rⱼ):
(a) determining the closest time (t_{Wn}) at which for the throughput parameter (Mᵢ(t_{Wn})) with a current recipe identifier (Rᵢ) an equivalent throughput parameter (Mⱼ(t_{Wn})) exists for the future recipe identifier (Rⱼ),
(b) determining a difference (ΔM=Mᵢ(t_{Wn})) between the throughput parameters (Mⱼ(t_{Wn})),
(c) adding a wear progress summand, which is calculated from the difference (ΔM=Mᵢ(t_{Wn}))−Mⱼ(t_{Wn}))), to the throughput parameter (Mᵢ(t_{Wn})) of the current recipe identifier, so that an estimated throughput parameter (Mᵢ(t_{Wn})) is obtained, and
(d) when the estimated throughput parameter lies below the threshold throughput parameter (Mⱼ(tₚ)) of the future material (20) with the future recipe identifier (Rⱼ), emitting an alarm.

6. The method according to claim 1, further comprising the steps: before a change from a current material (20) with a current recipe identifier (Rᵢ) to a future material (20) with a future recipe identifier (Rⱼ):
(a) determining the closest time (t_{Wn}) at which for the throughput parameter (Mᵢ(t_{Wn})) with a current recipe identifier (Rᵢ) an equivalent throughput parameter (Mⱼ(t_{Wn})) for the future recipe identifier (Rⱼ) exists,
(b) determining a quotient (Q=Mᵢ(t_{Wn}))/Mⱼ(t_{Wn})) of the throughput parameters (Mᵢ(t_{Wn}), (Mⱼ(t_{Wn})),
(c) multiplying a wear progress factor, which is calculated from the quotient (Q), with the throughput parameter (Mᵢ(t_{Wn})) of the current recipe identifier, so that a second estimated throughput parameter (Mᵢ(t_{Wn})) is obtained, and
(d) when the second estimated throughput parameter lies below the threshold throughput parameter (Mⱼ(tₚ)) of the future material (20) with the future recipe identifier (Rⱼ), emitting an alarm.

7. The method according to claim 1, further comprising the steps:
(a) for at least one predetermined recipe identifier (R₁) determining the throughput parameter (M₁(t)) as a function of time (t), and also from throughput parameters on extruding of materials (20) with other recipe identifiers (R₂, R₃, . . . ), and
(b) calculating an error time estimated value (t_{P,est}) at which the minimum throughput parameter (M_{1,min}) for the predetermined recipe identifier would fall below the minimum throughput parameter (M_{z,min}), which is assigned to the recipe identifier (R_{z}), by extrapolating the throughput parameter (M₁(t)).

8. The method according to claim 7, further comprising the step:
(a) for a predetermined amount of recipes
fitting a parameterised model function to the measured throughput parameters (Mᵢ(t_{W})), so that fit parameters are obtained,
(b) wherein the extrapolating of the throughput parameter (M₁(t)) takes place by means of the model function with the fit parameters.

9. A method for operating an extruder (12), which has a screw (14), with the steps:
(a) detecting a recipe identifier (Rᵢ) which
is assigned to material (20) which is to be extruded and
encodes at least one parameter, from which a target screw rotational frequency (fᵢ) of the screw (14), which is to be preset at the extrusion, is able to be determined,
(b) time-dependent detecting of a throughput parameter (Mᵢ(t)), from which a conclusion can be drawn regarding a throughput (Δm) of the extruder (12), comprising a throughput per revolution of the screw (14),
(c) at a change time (t_{W1}) changing the material (20) to be extruded to a material (20) with a second recipe identifier (Rⱼ),
(d) detecting a throughput parameter (Mᵢ(t_{W1})) for the material (20) with the first recipe identifier (Rᵢ) at the change time (t_{W1}) or a change time (t_{W1,e}) equivalent thereto, which lies within an equal wear interval (Iₑ), about the change time (t_{W1}),
(e) detecting the throughput parameter (Mⱼ(t_{W1})) for the material (20) with the second recipe identifier (Rⱼ) at the change time (t_{W1}) or a change time (t_{W1,e}) equivalent thereto, which lies within the equal wear interval (Iₑ) about the change time (t_{W1}),
(f) storing an equivalent throughput characteristic diagram (K), which
links the throughput parameter (Mᵢ(t_{W1})) for the material (20) with the first recipe identifier (Rᵢ) at the change time (t_{W1}) or the equivalent change time (t_{W1,e})
with the throughput parameter (Mⱼ(t_{W1})) for the material (20) with the second recipe identifier (Rⱼ) at the change time (t_{W1,e}).

10. The method according to claim 9, further comprising the steps:
(a) determining a recipe identifier as reference recipe identifier, and
(b) determining the equal wear intervals Iₑ(t_{Wk}) from the change times (t_{Wk}) of the reference recipe identifier.

11. The method according to claim 9, further comprising the steps:
(a) detecting an error time (t_{P}) at which the extruder (12), owing to too great a wear, is no longer able to be operated with the target screw rotational frequency (f_{i,soll}) (because otherwise the required quality of the product is no longer guaranteed),
(b) determining the throughput parameter (Mᵢ(t_{P})) at a time (t_{P}) in the equal wear interval (Iₑ),
(c) determining the minimum throughput parameter (M_{i,min}) from this throughput parameter (Mᵢ(t_{P})), by equalizing of minimum throughput parameter (M_{i,min}) and throughput parameter (Mᵢ(t_{P})).

12. A method for operating an extrusion system (10), which has
(a) a first extruder (12.1) and
(b) a second extruder (12.2) and
(c) at least a third extruder (12.3),
with the steps:
(d) carrying out a method according to claim 1 for the majority of the extruders.

13. An extruder (12) with
(a) a cylinder (16),
(b) at least one screw (14), which runs in the cylinder (16), and
(c) a control unit (24),
wherein
(d) the control unit (24) is arranged to automatically carry out a method according to claim 1.

14. An extrusion system (10) with
(a) a first extruder (12.1) with a first screw (14.1),
(b) a second extruder (12.2) with a second screw (14.2) and
(c) at least a third extruder (12.3) with a third screw (14.3),
(d) at least one control unit (24), which is arranged to automatically carry out the method according to claim 1.
